(19) United States
(12) Patent Application Publication
(10) Pub. No.: US 2024/0238889 A1
(43) Pub. Date: Jul. 18, 2024

(54) MULTI-PASS WELDING METHOD, MULTI-PASS BUTT WELDED JOINT, AND LAMINATION PATTERN CALCULATION METHOD FOR A MULTI-PASS WELD

(71) Applicant: Kabushiki Kaisha Kobe Seiko Sho (Kobe Steel, Ltd.), Kobe-shi (JP)

(72) Inventor: Takashi YASHIMA, Fujisawa-shi (JP)

(73) Assignee: Kabushiki Kaisha Kobe Seiko Sho (Kobe Steel, Ltd.), Kobe-shi (JP)

(21) Appl. No.: 18/559,110

(22) PCT Filed: Jun. 6, 2022
(86) PCT No.: PCT/JP2022/022862

§ 371 Date: Nov. 6, 2023

(30) Foreign Application Priority Data
Jul. 29, 2021 (JP) 2021-124523

(51) Int. Cl. B23K 9/02; B23K 9/127

(52) U.S. Cl. CPC B23K 9/0216; B23K 9/127

(57) ABSTRACT

A multi-pass welding method is provided for minimizing bead sagging and forming a welded joint having a good weld metal surface, even during multi-pass welding in a horizontal orientation, and a multi-pass butt welded joint and a lamination pattern calculation method for a multi-pass weld formed by the method. The weld metal has a plurality of layers from the rear surface of a base material to the front surface thereof. The plurality of layers include a finishing layer having at least two layers including an end layer; and a ground layer for forming the finishing layer. A boundary layer, which is the layer of the ground layer adjacent to the finishing layer, is formed such that the position of an upper plate-side weld is closer to the front surface of the base material than the position of a lower plate-side weld.

### TECHNICAL FIELD

The present invention relates to a multi-pass welding method capable of minimizing bead sagging and forming a welded joint having a favorable weld metal surface even during multi-pass welding in a horizontal orientation, a multi-pass butt welded joint formed in accordance with the multi-pass welding method, and a lamination pattern calculation method for a multi-pass weld.

### BACKGROUND ART

It is demanded that welding processes performed when manufacturing structures be labor-saving and be improved in terms of work efficiency than before, and in recent years, the application of welding robots has been increasing. Moreover, structures are increasing in size and design-specific steel structures are increasing. At welding sites, such as construction sites, portable welding robots are used for saving human labor or for improving work efficiency, and opportunities where work is performed automatically in various welding orientations are increasing. The various kinds of welding orientations include a flat orientation, a vertical orientation, and a horizontal orientation. Of these welding orientations, welding in the horizontal orientation is often performed for field welding and tends to involve a higher work load due to the weld length being greater than those in other welding orientations. Furthermore, since molten metal tends to sag and lead to defective external appearance, the level of difficulty in horizontal-orientation welding is high.

Of the aforementioned portable welding robots, three-axis portable welding robots widely used particularly at construction sites are often not equipped with torch-angle changing mechanisms. In that case, welding is performed at a fixed torch angle, so that the level of difficulty in horizontal-orientation welding is even higher. In a case of an L-shaped or V-shaped groove formed in a lower plate, bead sagging tends to occur particularly near the lower plate due to a difficulty in terms of workability, so that the level of difficulty further increases.

One of the reasons that horizontal-orientation welding is considered as being difficult is that bead sagging tends to occur due to the effect of gravity. Once bead sagging occurs, it is difficult to obtain a favorable external appearance of the joint. Therefore, the welding has to be temporarily suspended, and a process for adjusting the bead shape by grinding is necessary. Furthermore, there is a high possibility that bead sagging may occur at a finishing layer of the multi-pass weld, sometimes requiring a countermeasure by, for example, installing a front backing member. Performing grinding or installing a front backing member leads to an increased cycle time, and is not desirable from the standpoint of work efficiency.

Patent Literature 1 discloses a welding method that involves increasing a downward movement time of a weld wire relative to an upward movement time when performing horizontal-orientation welding while oscillating the weld wire in the vertical direction, and applying a magnetic field to a molten pool being welded so as to cause a stirring force to occur in a direction for lifting molten metal, thereby forming a flat weld bead.

Patent Literature 2 describes an automatic welding method involving arranging at least three sets of wire feeding components within a weld head in an axial direction of a wire and displacing, in the vertical direction, the centrally-located wire feeding component of the three sets of wire feeding components relative to an axis connecting the two sets of externally-located wire feeding components so as to feed the wire while adding a bending habit to the wire in the vertical direction and to weld an upper surface or a lower surface within a groove joint.

### CITATION LIST

### Patent Literature

PTL 1: Japanese Unexamined Patent Application Publication No. 63-108973
PTL 2: Japanese Unexamined Patent Application Publication No. 08-309524

### SUMMARY OF INVENTION

### Technical Problem

However, the welding methods disclosed in Patent Literatures 1 and 2 additionally require special devices, such as a dedicated magnetic field generator for generating a lifting force in the molten metal and a wire feeder for feeding the wire while adding a bending habit to the wire in the vertical direction. This is problematic in terms of, for example, an increase in work time for installing the devices and an increase in installation costs. Furthermore, when an automatic device is to be used, the device increases in size. From the standpoint of transportability, such as portability, and operability, this is problematic in terms of difficult application particularly to a portable welding robot that is more preferably lightweight and compact and to a welding apparatus using a carriage as transport means.

The present invention has been made in view of the problems mentioned above, and an object thereof is to provide a multi-pass welding method capable of minimizing bead sagging and forming a welded joint having a favorable weld metal surface even during multi-pass welding in a horizontal orientation, a multi-pass butt welded joint formed in accordance with the multi-pass welding method, and a lamination pattern calculation method for a multi-pass weld.

### Solution to Problem

Accordingly, the aforementioned object of the present invention is achieved in accordance with the following configuration [1] related to a multi-pass welding method.

[1] A multi-pass welding method comprising forming weld metal by multi-pass welding in a horizontal orientation so as to join a pair of pieces of a base material constituted of an upper plate and a lower plate disposed to form a groove,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein the boundary layer is formed such that a position P_{UB} of an upper-plate-side weld at the boundary layer is closer to the front surface of the base material than a position PLB of a lower-plate-side weld at the boundary layer.

Furthermore, the aforementioned object of the present invention is achieved in accordance with the following configuration [2] related to a multi-pass butt welded joint.

[2] A multi-pass butt welded joint in which a pair of pieces of a base material constituted of an upper plate and a lower plate disposed to form a groove are joined via weld metal formed by multi-pass welding,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein a position P_{UB} of an upper-plate-side weld at the boundary layer is closer to the front surface of the base material than a position PLB of a lower-plate-side weld at the boundary layer.

Furthermore, the aforementioned object of the present invention is achieved in accordance with the following configuration [3] related to a lamination pattern calculation method for a multi-pass weld.

[3] A lamination pattern calculation method for a multi-pass weld, the lamination pattern calculation method being for performing the multi-pass welding method according to [1], wherein
a database in which work information and at least two pieces of positional information are associated with each other is provided, the work information at least including information about a groove shape, a groove angle, and a thickness of the base material, the at least two pieces of positional information being at least two pieces of positional information among positional information about the position P_{UB}, positional information about the position P_{LB}, and relative positional information between the position P_{UB} and the position P_{LB}, and
the lamination pattern calculation method comprises a step for setting a lamination pattern based on the database, the lamination pattern including a number of lamination layers and a position of the boundary layer.

### Advantageous Effects of Invention

According to the multi-pass welding method of the present invention, bead sagging can be minimized and a welded joint having a favorable weld metal surface can be formed even during multi-pass welding in a horizontal orientation.

### BRIEF DESCRIPTION OF DRAWINGS

FIG. 1 is a schematic diagram illustrating an embodiment of a welding system equipped with a portable welding robot that uses a multi-pass welding method according to this embodiment.

FIG. 2 is a schematic side view of the portable welding robot.

FIG. 3 is a perspective view of the portable welding robot.

FIG. 4 is a perspective view illustrating in a case where the portable welding robot is attached to a polygonal steel pipe.

FIG. 5 is macro-photograph illustrating a cross section of a multi-pass butt welded joint formed in accordance with the multi-pass welding method according to this embodiment.

FIG. 6 is a cross-sectional view schematically illustrating a ground layer of the multi-pass butt welded joint formed in accordance with a welding pattern 1.

FIG. 7 is a cross-sectional view schematically illustrating the ground layer of the multi-pass butt welded joint formed in accordance with a welding pattern 2.

FIG. 8 is a cross-sectional view schematically illustrating the ground layer of the multi-pass butt welded joint formed in accordance with a welding pattern 3.

FIG. 9 is a cross-sectional view schematically illustrating a state where horizontal-orientation welding is performed on a groove at a fixed torch angle.

FIG. 10 is a cross-sectional view schematically illustrating a state prior to welding a final pass in a third layer, that is, a weld pass in contact with a groove surface of an upper plate.

### DESCRIPTION OF EMBODIMENTS

An embodiment of a multi-pass welding method according to the present invention will be described in detail below based on the drawings. This embodiment that uses a portable welding robot is an example that maximally exhibits the advantages of the present invention, and may be applicable to, for example, a welding apparatus using a carriage as transport means, a six-axis industrial robot, or manual welding by an operator.

### <1. Welding System>

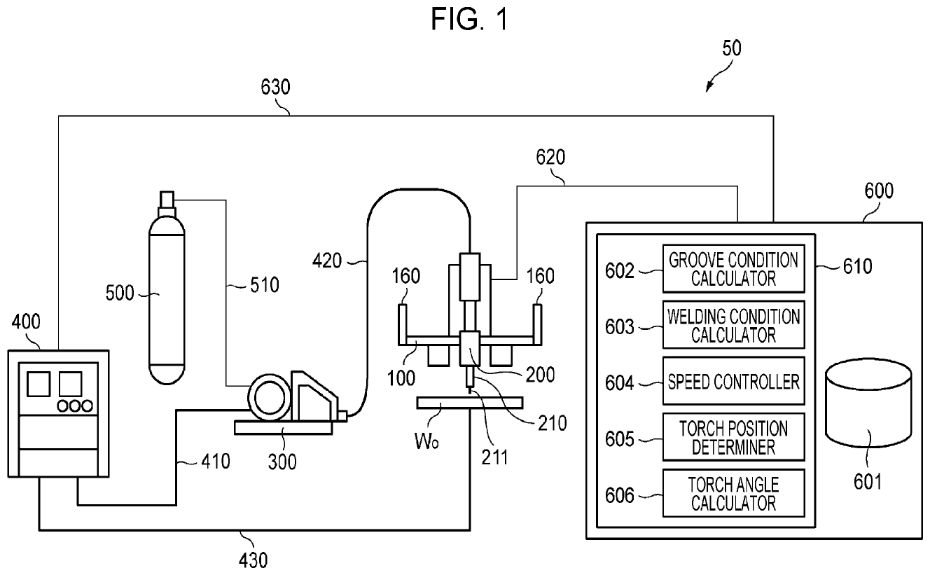

First, a welding system 50 equipped with a portable welding robot 100 will be described with reference to FIGS. 1 to 4.

FIG. 1 is a schematic diagram illustrating the configuration of a welding system according to this embodiment. As shown in FIG. 1, the welding system 50 includes the portable welding robot 100, a feeding device 300, a welding power source 400, a shield-gas supply source 500, and a control device 600.

### (1-1. Control Device)

The control device 600 is connected to the portable welding robot 100 by a robot control cable 620, and is connected to the welding power source 400 by a power-source control cable 630.

The control device 600 has a data retainer 601 that preliminarily retains teaching data defining, for example, workpiece information, guide rail information, positional information about a workpiece Wo serving as a base material to be welded and a guide rail 120, an operation pattern of the portable welding robot 100, a welding start position, a welding end position, a welding condition, and a weaving operation. The control device 600 sends a command to the portable welding robot 100 and the welding power source 400 based on this teaching data, and controls the operation and the welding condition of the portable welding robot 100.

Furthermore, the control device 600 has a groove condition calculator 602 that calculates groove shape information from detection data obtained by touch sensing or sensing of, for example, a visual sensor, and a welding condition calculator 603 that acquires a welding condition by correcting the welding condition in the aforementioned teaching data based on the groove shape information. The control device 600 also has a speed controller 604 that controls a driver for driving the portable welding robot 100 in an X direction, a Y direction, and a Z direction to be described later, a torch position determiner 605 that determines a torch position, and a torch angle calculator 606 that controls a movable arm 116 serving as a torch angle driver in the portable welding robot 100. A control unit 610 including the groove condition calculator 602, the welding condition calculator 603, the speed controller 604, the torch position determiner 605, and the torch angle calculator 606 is constituted. The torch position determiner 605 and the torch angle calculator 606 may be grouped into a single unit.

Furthermore, the control device 600 is formed by integrating a controller for performing teaching and a controller having other control functions with each other. However, the control device 600 is not limited to this, and may be split into multiple units depending on the functions by, for example, separating the controller for performing teaching and the controller having other control functions from each other as two units. The control device 600 may be included in the portable welding robot 100, or the control device 600 may be provided independently of the portable welding robot 100, as shown in FIG. 1. Specifically, the welding system having the portable welding robot 100 and the control device 600 described in this embodiment includes both a case where the control device 600 is included in the portable welding robot 100 and a case where the control device 600 is provided independently of the portable welding robot 100. Furthermore, although a signal is transmitted by using the robot control cable 620 and the power-source control cable 630 in this embodiment, the configuration is not limited to this, and the signal may be transmitted wirelessly. From the standpoint of usability at a welding site, it is preferable that the controller for performing teaching and the controller having other control functions be separated from each other as two units.

### (1-2. Welding Power Source)

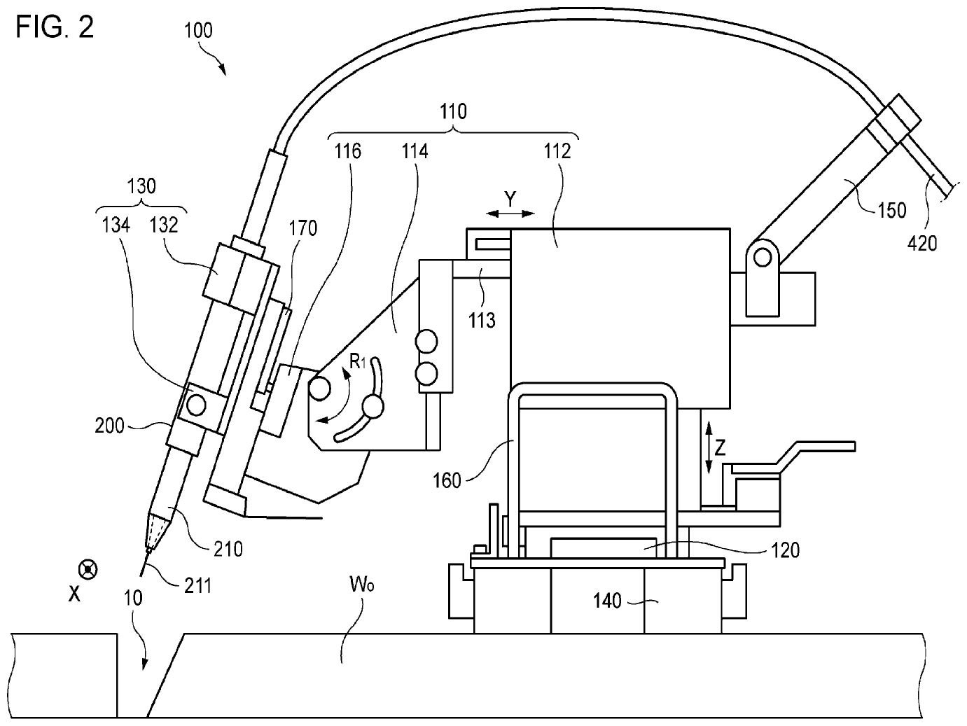

The welding power source 400 supplies electric power to a consumable electrode (sometimes referred to as “weld wire” hereinafter) 211 and the workpiece Wo based on a command from the control device 600, so as to generate an arc between the weld wire 211 and the workpiece Wo. The electric power from the welding power source 400 is sent to the feeding device 300 via a power cable 410, and is sent to a welding torch 200 from the feeding device 300 via a conduit tube 420. Then, as shown in FIG. 2, the electric power is supplied to the weld wire 211 via a contact tip at the distal end of the welding torch 200. An electric current during a welding process may be a direct current or an alternating current, and the waveform thereof is not particularly limited. Therefore, the electric current may be a pulse having, for example, a rectangular wave or a triangular wave.

The welding power source 400 is connected to the welding torch 200 via the power cable 410 as a positive (+) electrode, and is connected to the workpiece Wo via a power cable 430 as a negative (−) electrode. This corresponds to a case of reverse-polarity welding. In a case of straight-polarity welding, the welding power source 400 may be connected to the workpiece Wo via a positive power cable and may be connected to the welding torch 200 via a negative power cable.

### (1-3. Shield-Gas Supply Source)

The shield-gas supply source 500 is constituted of a shield-gas-filled container and an accessory member, such as a valve. The shield gas is sent from the shield-gas supply source 500 to the feeding device 300 via a gas tube 510. The shield gas sent to the feeding device 300 is sent to the welding torch 200 via the conduit tube 420. The shield gas sent to the welding torch 200 flows through the welding torch 200, is guided to a nozzle 210, and is ejected from the distal end of the welding torch 200. The shield gas used in this embodiment may be, for example, an argon (Ar) gas, a carbon dioxide (CO₂) gas, or a mixture of these gases.

### (1-4. Feeding Device)

The feeding device 300 feeds and sends the weld wire 211 to the welding torch 200. The weld wire 211 fed by the feeding device 300 is not particularly limited and is selected in accordance with, for example, the material and the weld form of the workpiece Wo. For example, a solid wire or a flux-cored wire is used. The material of the weld wire 211 is also not limited and may be, for example, soft steel, stainless steel, aluminum, or titanium. Moreover, although the wire diameter of the weld wire 211 is not particularly limited, a preferred wire diameter in this embodiment is 1.6 mm as an upper limit and 0.9 mm as a lower limit.

The conduit tube 420 according to this embodiment has an electric conductive path functioning as a power cable at the outer sheath side of the tube, a protective tube for protecting the weld wire 211 inside the tube, and a shield-gas flow path. However, the conduit tube 420 is not limited to this, and may be, for example, a bundle of power supplying cables and shield-gas supplying hoses arranged around the protective tube for feeding the weld wire 211 to the welding torch 200. As another example, a tube for feeding the weld wire 211 and the shield gas and a power cable may be disposed independently of each other.

### (1-5. Portable Welding Robot)

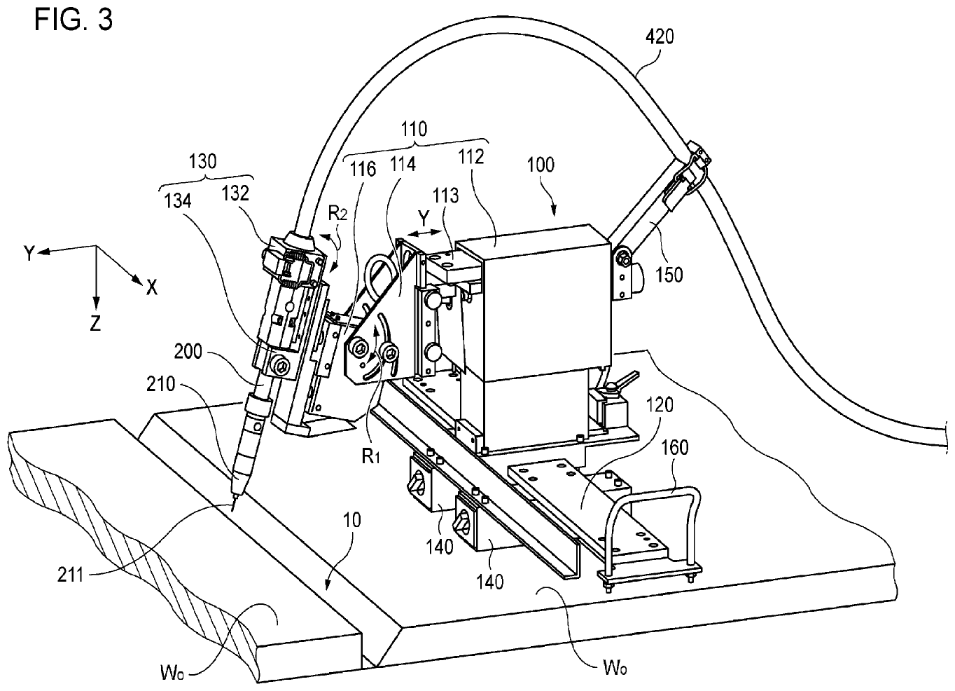

As shown in FIGS. 2 and 3, the portable welding robot 100 includes the guide rail 120, a robot body 110 that is disposed on the guide rail 120 and that moves along the guide rail 120, and a torch connector 130 placed on the robot body 110. The robot body 110 is mainly constituted of a housing 112 disposed on the guide rail 120, a stationary arm 114 attached to the housing 112, and a movable arm 116 attached to the stationary arm 114 in such a manner as to be rotatable in a direction of an arrow R₁.

The torch connector 130 is attached to the movable arm 116 via a crank 170 serving as a movable section that allows the welding torch 200 to be movable in a weld line direction, that is, the X direction. The torch connector 130 includes a torch clamp 132 and a torch clamp 134 for securing the welding torch 200. The housing 112 is provided with a cable clamp 150 that supports the conduit tube 420 connecting the feeding device 300 and the welding torch 200 to each other at the opposite side from the side where the welding torch 200 is attached.

In this embodiment, voltage is applied between the workpiece Wo and the weld wire 211, and, for example, the surface of a groove 10 in the workpiece Wo is detected by utilizing a voltage drop phenomenon occurring when the weld wire 211 comes into contact with the workpiece Wo. A touch sensor is used as detecting means. The detecting means is not limited to the touch sensor according to this embodiment, and may be an image sensor, that is, visual sensing, a laser sensor, that is, laser sensing, or a combination of these detecting means. However, it is preferable that the touch sensor according to this embodiment be used for simplifying the device configuration.

As indicated by an arrow X in FIG. 2, the housing 112 of the robot body 110 includes a robot driver (not shown) that drives the housing 112 in a direction orthogonal to the plane of the drawing, that is, in the X direction in which the robot body 110 moves along the guide rail 120. The housing 112 is also drivable in the Z direction that is orthogonal to the X direction and in which it moves in the depth direction of the groove 10. The stationary arm 114 is drivable relative to the housing 112 via a slide supporter 113 in the Y direction orthogonal to the X direction and serving as the width direction of the groove 10.

Furthermore, the torch connector 130 having the welding torch 200 attached thereto is drivable in an oscillating fashion in the front-rear direction in the X direction, that is, the weld line direction, as a result of the crank 170 rotating as indicated by an arrow R₂ in FIG. 3. As indicated by the arrow R₁, the movable arm 116 is rotatably attached to the stationary arm 114 and can be secured while being adjusted to an optimal angle.

Accordingly, the robot body 110 is capable of driving the welding torch 200 serving as the distal end thereof in three degrees of freedom. However, the robot body 110 is not limited to this, and may be drivable in any number of degrees of freedom depending on the intended usage.

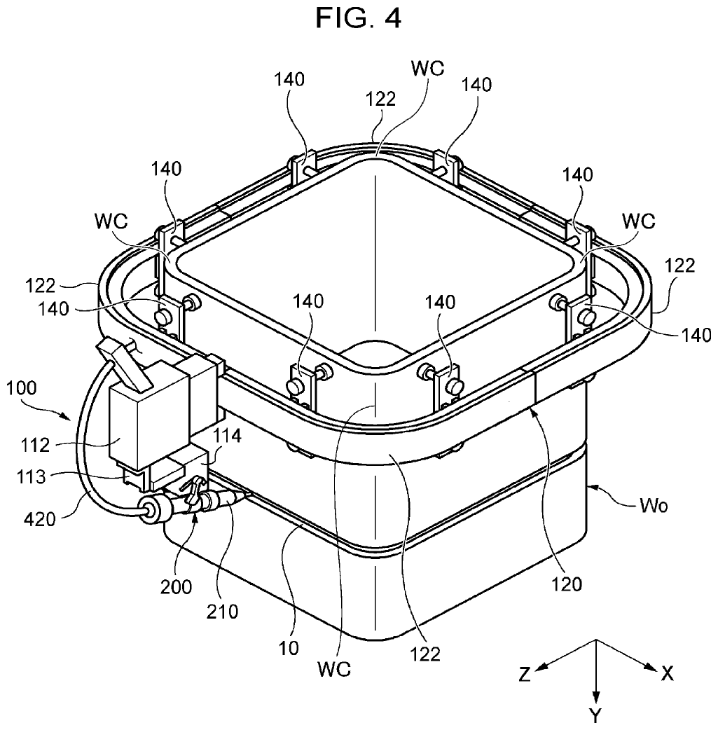

With the above configuration, the distal end of the welding torch 200 attached to the torch connector 130 can be oriented in any direction. Moreover, the robot body 110 is drivable in the X direction in FIG. 2 along the guide rail 120. With the robot body 110 moving in the X direction while reciprocating in the Y direction, the welding torch 200 can perform weaving welding. Furthermore, in accordance with driving by the crank 170, for example, the welding torch 200 can be tilted depending on the work condition, such as a push angle or a drag angle. Moreover, by tilting the welding torch 200 in the X direction in accordance with the driving by the crank 170, a variation in torch angle, that is, the push angle or the drag angle, occurring when corners WC of the workpiece Wo, such as a polygonal steel pipe, and curved portions 122 of the guide rail 120 have different curvatures, as shown in FIG. 4, can be corrected.

An attachment member 140, such as a magnet, is provided below the guide rail 120. By using the attachment member 140, the guide rail 120 is readily attachable to and detachable from the workpiece Wo. When the portable welding robot 100 is to be set on the workpiece Wo, an operator can readily set the portable welding robot 100 on the workpiece Wo by holding opposite handles 160 of the portable welding robot 100.

### <2. Multi-Pass Welding Method in Horizontal Orientation>

Next, a multi-pass welding method in a horizontal orientation using the aforementioned portable welding robot 100 will be described.

Normal welding in a horizontal orientation is basically performed by “stringer bead” except for the root pass. Stringer bead refers to electrode manipulation involving performing welding linearly without performing weaving. From the standpoint of preventing bead sagging, low-heat input welding is normally performed. However, when stringer bead is executed with low heat input, since the bead tends to have a convex shape, welding is normally performed after setting an optimal torch angle for each pass, so that a streaky finished shape can be obtained. Examples of a welding technique in which the torch angle is settable to any angle include welding by a skilled worker and welding using an industrial robot having six or more axes.

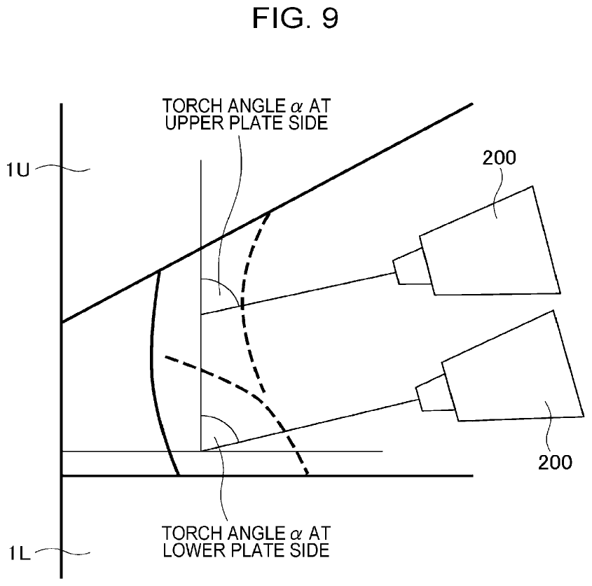

On the other hand, the portable welding robot 100 is normally not equipped with a torch-angle changing mechanism. Therefore, as shown in FIG. 9, even in horizontal-orientation welding, the welding is performed in all the passes at a fixed torch angle α with respect to an upper-plate torch angle and a lower-plate torch angle. Thus, in addition to the difficulty in performing the horizontal-orientation welding at the fixed torch angle α, the torch angle cannot be set to an optimal condition depending on the circumstances, thus causing bead sagging to occur more readily. Furthermore, in a case of an L-shaped or V-shaped groove formed in the lower plate (sometimes collectively referred to as “lower groove” hereinafter), bead sagging particularly tends to occur near the lower plate due to a difficulty in terms of workability.

Therefore, in this embodiment, in order to obtain a good external appearance of a joint not only in the case of the horizontal orientation, which is a difficult orientation, but also in the case of welding at the fixed torch angle α or the L-shaped or V-shaped groove where bead sagging tends to occur, it is necessary to properly form the bead shape at a “ground layer” in a stage previous to that of a “finishing layer” to be described later, in view of bead sagging occurring at the “finishing layer”, particularly, at an “end layer”. Three welding patterns used when forming the ground layer will be described below.

### (2-1. Welding Pattern 1)

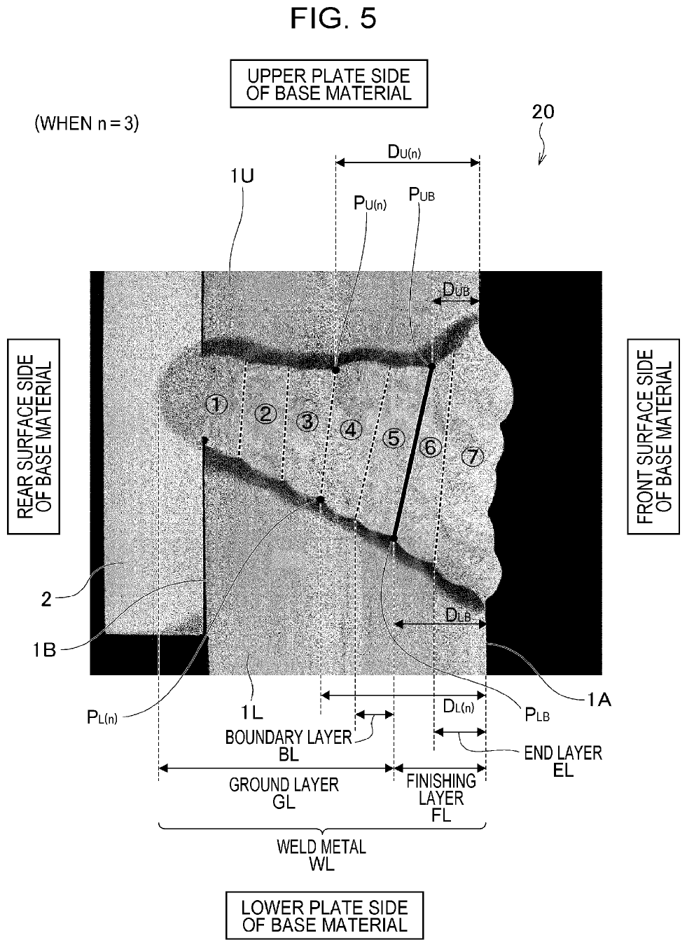

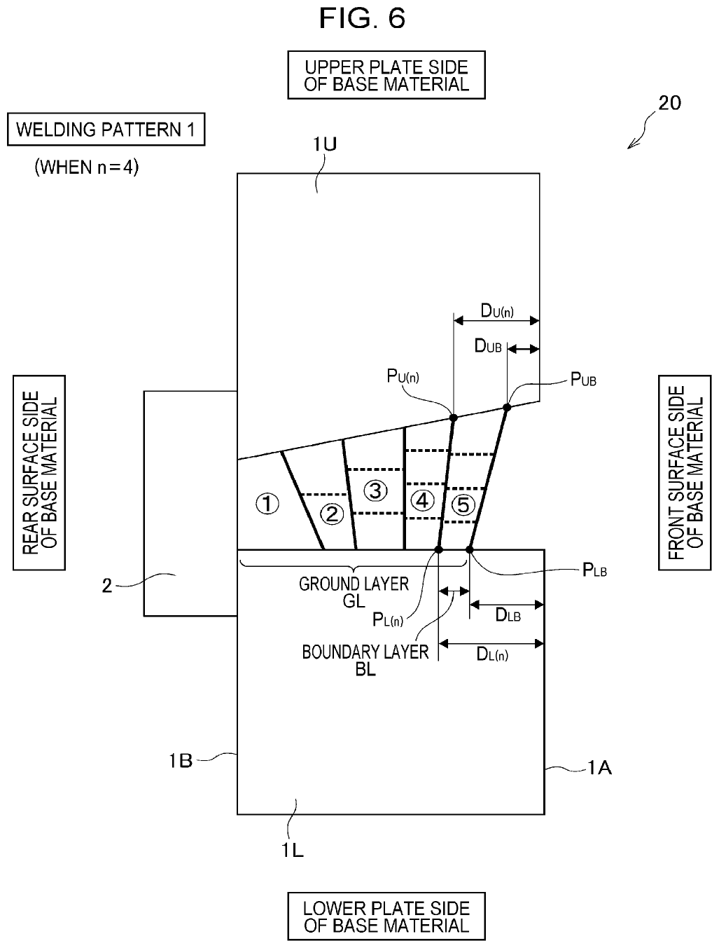

FIG. 5 is a cross-sectional macro photograph of a multi-pass butt welded joint 20 formed in accordance with the multi-pass welding method in the horizontal orientation using a welding pattern 1. FIG. 6 is a schematic cross-sectional view of a ground layer GL formed by performing the multi-pass welding method according to the welding pattern 1.

With regard to the welded joint 20 shown in FIG. 5, a lower plate 1L and an upper plate 1U serving as the base material and each having a thickness of 25 mm and composed of SM490A are disposed in the horizontal orientation of the lower groove, and horizontal-orientation welding is performed in accordance with weld metal WL formed of seven layers by using backing metal 2. The lower groove in this case is specifically an L-shaped groove formed at the lower plate side. Specifically, the weld metal WL is formed of the ground layer GL having five layers denoted by circled numbers 1 to 5 in FIG. 5 and a finishing layer FL having two layers denoted by circled numbers 6 and 7. In FIG. 5, a dashed line in each layer schematically indicates the boundary of each pass. In principle, the passes are laminated sequentially toward the upper plate 1U from the pass closer to the lower plate 1L.

In this lower-groove and horizontal-orientation welding, bead sagging tends to occur, possibly having a significant effect on the external appearance of the joint.

In the following description, a plurality of layers will be described such that at least two layers including an end layer EL serve as the finishing layer FL, a layer as a foundation for the finishing layer FL serves as the ground layer GL, and a layer of the ground layer GL that is adjacent to the finishing layer FL serves as a boundary layer BL. The “plurality of layers” in this case are seven layers in the embodiment shown in FIG. 5, and the “boundary layer BL” is the fifth layer.

In each layer, the position of a weld at the upper plate 1U side will be defined as P_{U(n)}, and the position of a weld at the lower plate 1L side will be defined as P_{L(n)}. In this case, n denotes the number of layers. In detail, FIG. 5 illustrates a case where n=3, and FIG. 6 illustrates a case where n=4.

The position of a weld refers to the position located closest toward the front surface in a boundary area between the upper plate 1U or the lower plate 1L in each layer and the weld metal WL. Therefore, in a case where the fifth layer serves as the boundary layer BL, the upper-plate-side weld of the boundary layer BL is located at a position P_{UB}=P_{U(5)}, and the lower-plate-side weld of the boundary layer BL is located at a position P_{LB}=P_{L(5)}.

A front surface 1A of each of the upper plate 1U and the lower plate 1L serving as the base material in FIG. 5 is the right side surface, and a rear surface 1B is the left side surface.

In the welded joint 20 according to this embodiment, the position P_{UB} of the upper-plate-side weld of the boundary layer BL is closer to the front surface 1A of the base material than the position P_{LB} of the lower-plate-side weld of the boundary layer BL.

In detail, a distance D_{UB} from the front surface 1A of the upper plate 1U at the position P_{UB} of the upper-plate-side weld ranges between 2 mm and 12 mm, and a distance D_{LB} from the front surface 1A of the lower plate 1L at the position P_{LB} of the lower-plate-side weld ranges between 4 mm and 16 mm. Furthermore, a difference D_{LB}−D_{UB} between the distance D_{LB} from the front surface 1A of the lower plate 1L at the position P_{LB} Of the lower-plate-side weld and the distance D_{UB} from the front surface 1A of the upper plate 10 at the position P_{UB} of the upper-plate-side weld is between 1 mm and 10 mm inclusive.

By forming the boundary layer BL having a slope such that the distance D_{LB} is larger than the distance D_{UB}, a space larger than at the upper plate 1U side is ensured at the lower plate 1L even if bead sagging occurs in the horizontal-orientation welding in which bead sagging tends to occur, so that the molten metal can be accommodated within the space. Therefore, the weld metal can have a favorable surface shape, and the finishing layer FL with a good external appearance can be readily formed.

Although the finishing layer FL may be a single layer, it is preferable that the finishing layer FL include two or more layers since the finishing layer FL with a good external appearance can be readily formed by gradually correcting the slope of the plurality of layers including the two or more layers.

With regard to welding according to the welding pattern 1 shown in FIG. 6, relationships related to the boundary layer BL, such as work information including the groove shape, the groove angle, and a thickness X of the base material, positional information about the position P_{LB} Of the lower-plate-side weld, positional information about the position P_{UB} of the upper-plate-side weld, and relative positional information between the position P_{LB} of the lower-plate-side weld and the position P_{UB} of the upper-plate-side weld, may be obtained in advance, and, for example, table 1 indicated below may be created.

TABLE 1

| | | POSITIONAL | POSITIONAL |
|---|---|---|---|
| GROOVE | GROOVE | INFORMATION | INFORMATION |
| SHAPE | ANGLE | OF P_{LB} | OF P_{UB} |
| L- | 5° TO 20° | X - (4 mm to 8 mm) | X - (2 mm to 6 mm) |
| SHAPED | 20° TO 40° | X - (6 mm to 12 mm) | X - (3 mm to 9 mm) |
| | 40° TO 60° | X - (6 mm to 16 mm) | X - (4 mm to 12 mm) |

X denotes the thickness (mm) of the base material.

Based on the work information, the target shape of the boundary layer BL is set by manually obtaining at least two pieces of positional information among the positional information about the position P_{LB} Of the lower-plate-side weld, the positional information about the position P_{UB} of the upper-plate-side weld, and the relative positional information between the position P_{LB} of the lower-plate-side weld and the position P_{UB} of the upper-plate-side weld from table 1 indicated above.

In order to obtain the boundary layer BL having such a shape by welding, the welding according to the welding pattern 1 involves laminating the layers in the ground layer GL such that a difference D_{L(n)}−D_{U(n)} between the distance D_{L(n)} from the front surface 1A of the base material at the position P_{L(n)} of the lower-plate-side weld and the distance D_{U(n)} from the front surface 1A of the base material at the position P_{U(n)} of the upper-plate-side weld increases sequentially until the boundary layer BL is reached, as shown in FIG. 6. In order to form the ground layer GL with no defects, the slopes of the layers in the ground layer GL may be adjusted to gradually approach the slope of the boundary layer BL from the first layer toward the fifth layer. Such an adjustment enables easy formation of the slope of the boundary layer BL, which is difficult to form since the weld in the upper-plate-side weld pass tends to sag due to the effect of gravity. The number n of lamination layers and the number of passes may be set manually based on the work information.

The number n of lamination layers, the number of passes, the layers in the ground layer GL, and the boundary layer BL mentioned above may be set automatically instead of being set manually. Specifically, with regard to the number n of lamination layers, the number n of lamination layers is determined by inputting the work information, such as the groove shape, the groove angle, and the thickness X of the base material, to a predetermined arithmetic expression. Then, based on a database that accumulates data in which the work information is associated with at least two pieces of positional information among the positional information about the position P_{LB} of the lower-plate-side weld of the boundary layer BL, the positional information about the position P_{UB} of the upper-plate-side weld, and the relative positional information between the position P_{LB} Of the lower-plate-side weld and the position P_{UB} of the upper-plate-side weld, each lamination pattern including the position of the boundary layer BL is set. Furthermore, the number of passes in each layer is obtained by inputting the number n of lamination layers to another arithmetic expression for determining the number of passes.

For example, if the number n of lamination layers is determined to be eight layers from the arithmetic expression, it is determined which layer of the eight layers is to serve as the boundary layer BL based on the database. If the fifth layer is determined as the boundary layer BL, the welding patterns of the ground layer GL and the finishing layer FL and the number of passes in each layer are set with the fifth layer serving as the boundary layer BL. Then, the ground layer GL, the boundary layer BL, and the finishing layer FL are formed while adjusting weaving to be described later, the welding speed, and the target position for the wire tip, so that the determined shapes are satisfied.

According to the welding pattern 1 in which the difference D_{L(n)}−D_{U(n)} between the distances D_{L(n)} and D_{U(n)} from the front surface 1A of the base material increases sequentially until the boundary layer BL is reached, the arithmetic expressions for determining the number n of lamination layers and the number of passes are simplified, so that the lamination conditions can be readily calculated.

The multi-pass welding method described above is not limited to the L-shaped groove shown in FIG. 5 and may be applied to a groove having another shape, such as an I-shaped groove or a V-shaped groove.

### (2-2. Welding Pattern 2)

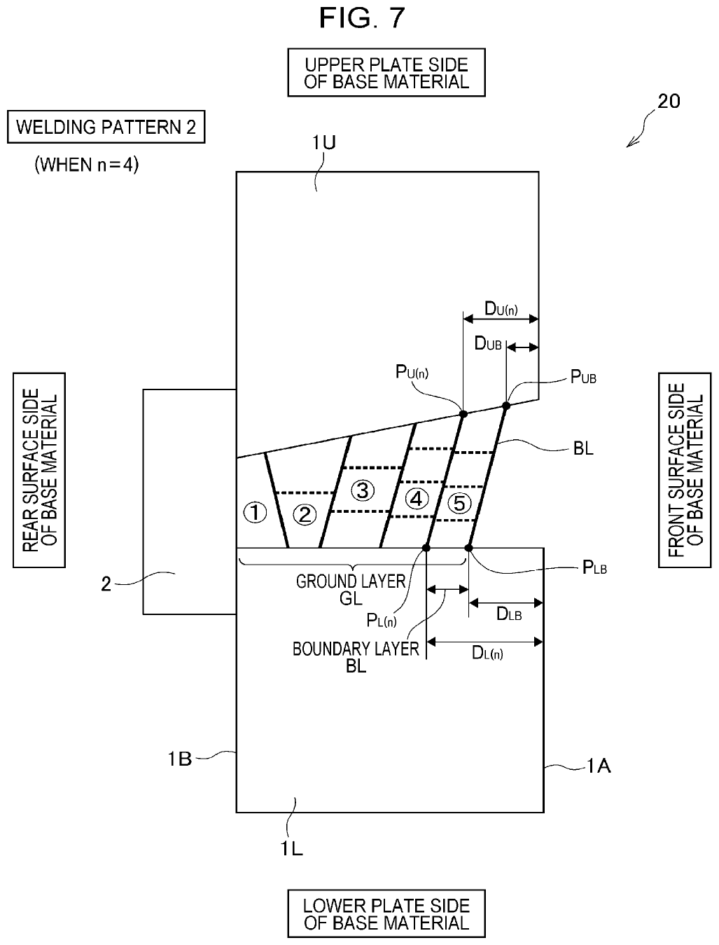

As shown in FIG. 7, in the multi-pass welding method in the horizontal orientation according to a welding pattern 2, the position P_{UB} Of the upper-plate-side weld of the boundary layer BL is closer to the front surface 1A of the base material than the position P_{LB} of the lower-plate-side weld of the boundary layer BL. In detail, the distance D_{UB} from the front surface 1A of the upper plate 1U at the position P_{UB} of the upper-plate-side weld ranges between 2 mm and 12 mm, and the distance Dis from the front surface 1A of the lower plate 1L at the position P_{LB} of the lower-plate-side weld ranges between 4 mm and 16 mm. Furthermore, the difference D_{LB}−D_{UB} between the distance D_{UB} from the front surface 1A of the lower plate 1L at the position P_{UB} of the lower-plate-side weld and the distance D_{UB} from the front surface 1A of the upper plate 10 at the position P_{UB} of the upper-plate-side weld is between 1 mm and 10 mm inclusive. FIG. 7 illustrates an example where n=4.

In welding according to the welding pattern 2, a plurality of ground layers GL are continuously formed such that the difference D_{L(n)}−D_{U(n)} between the distance D_{L(n)} from the front surface 1A of the lower plate 1L at the position P_{L(n)} of the lower-plate-side weld and the distance D_{U(n)} from the front surface 1A of the upper plate 1U at the position PU(m) of the upper-plate-side weld is positive until the boundary layer BL is reached from a predetermined layer, that is, the second layer in FIG. 7. With the ground layers GL formed in this manner, the boundary layer BL having a desired shape can be readily formed when a welded joint having a favorable weld metal surface is to be formed. Furthermore, according to the welding pattern 2, a large amount of weld metal can be provided from the first layer toward the upper plate 1U, and a target angle can be achieved for the slope of the boundary layer BL at an early stage, thereby further facilitating the angle adjustment of the slope.

### (2-3. Welding Pattern 3)

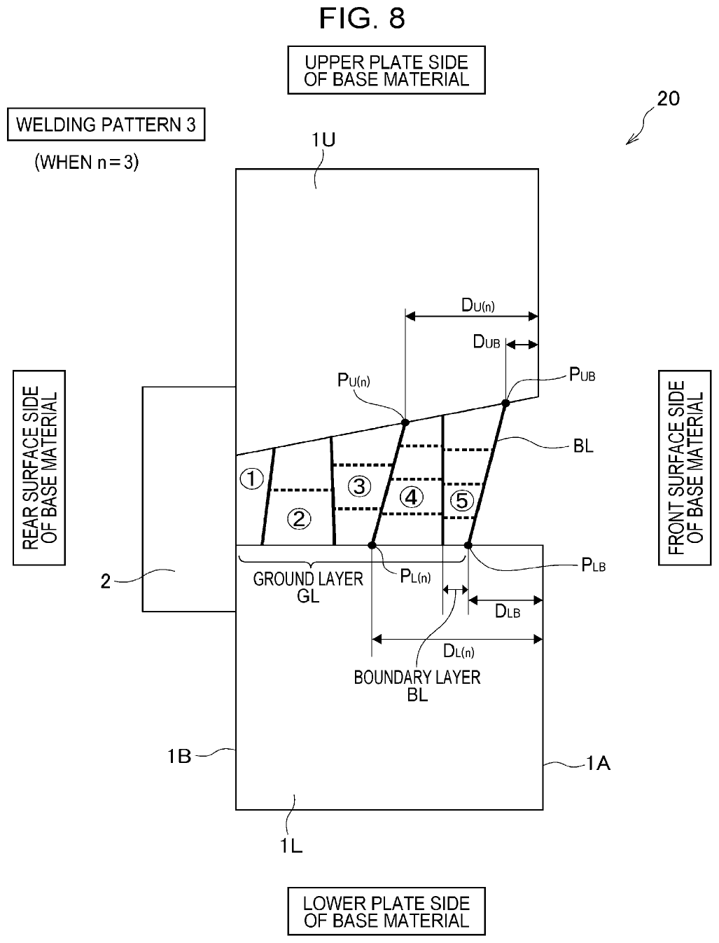

As shown in FIG. 8, in the multi-pass welding method in the horizontal orientation according to a welding pattern 3, the position P_{UB} of the upper-plate-side weld of the boundary layer BL is closer to the front surface 1A of the base material than the position P_{UB} of the lower-plate-side weld of the boundary layer BL. In detail, the distance D_{UB} from the front surface 1A of the upper plate 1U at the position P_{UB} of the upper-plate-side weld ranges between 2 mm and 12 mm, and the distance Dis from the front surface 1A of the lower plate 1L at the position P_{LB} of the lower-plate-side weld ranges between 4 mm and 16 mm. Furthermore, the difference D_{LB}−D_{UB} between the distance D_{UB} from the front surface 1A of the lower plate 1L at the position P_{LB} of the lower-plate-side weld and the distance D_{UB} from the front surface 1A of the upper plate 1U at the position P_{UB} of the upper-plate-side weld is between 1 mm and 10 mm inclusive. FIG. 8 illustrates an example where n=3.

With regard to ground layers GL according to the welding pattern 3, the layers are laminated such that the difference D_{L(n)}−D_{U(n)} between the distance D_{L(n)} from the front surface 1A of the lower plate 1L at the position P_{L(n)} of the lower-plate-side weld and the distance D_{U(n)} from the front surface 1A of the upper plate 1U at the position P_{U(n)} of the upper-plate-side weld alternates between positive and negative until the boundary layer BL is reached. In the embodiment shown in FIG. 8, the position P_{L(n)} of the lower-plate-side weld at each of the second and fourth ground layers GL is closer to the front surface 1A of the lower plate 1L serving as the base material than the position P_{U(n)} of the upper-plate-side weld, and the position P_{L(n)} of the lower-plate-side weld at each of the third and fifth layers is farther from the front surface 1A of the lower plate 1L serving as the base material than the position P_{U(n)} of the upper-plate-side weld.

With the ground layers GL formed in this manner, the boundary layer BL having a desired shape can be readily formed when a welded joint having a favorable weld metal surface is to be formed. Furthermore, according to the welding pattern 3, the space of the final pass of each layer, that is, the weld pass in contact with the groove surface of the upper plate, as will be described later, can be readily ensured, and the external appearance and the weld quality can both be readily achieved.

Accordingly, with the boundary layer BL of a desired shape formed in accordance with any one of the welding patterns 1 to 3, the lower-plate-side weld has a larger dimension in the thickness direction than the upper-plate-side weld due to an effect on the bead shape caused by gravity when the finishing layer is welded. As a result, the weld metal can have a favorable surface shape at the end layer, and a welded joint with a good external appearance can be formed.

When forming the aforementioned welding patterns, examples of a method for adjusting the shape of each layer and the amount of weld in each pass include factors (A) to (C) indicated below.

### (A) Weaving

By providing a frequency of 1 Hz to 3 Hz, a weaving width of 0.5 mm to 1.5 mm, and a weaving stoppage period of 0 sec to 0.5 sec, a favorable bead that enables a readily adjustable joint shape can be formed.

### (B) Target Position for Wire Tip and Ensured Welding Space

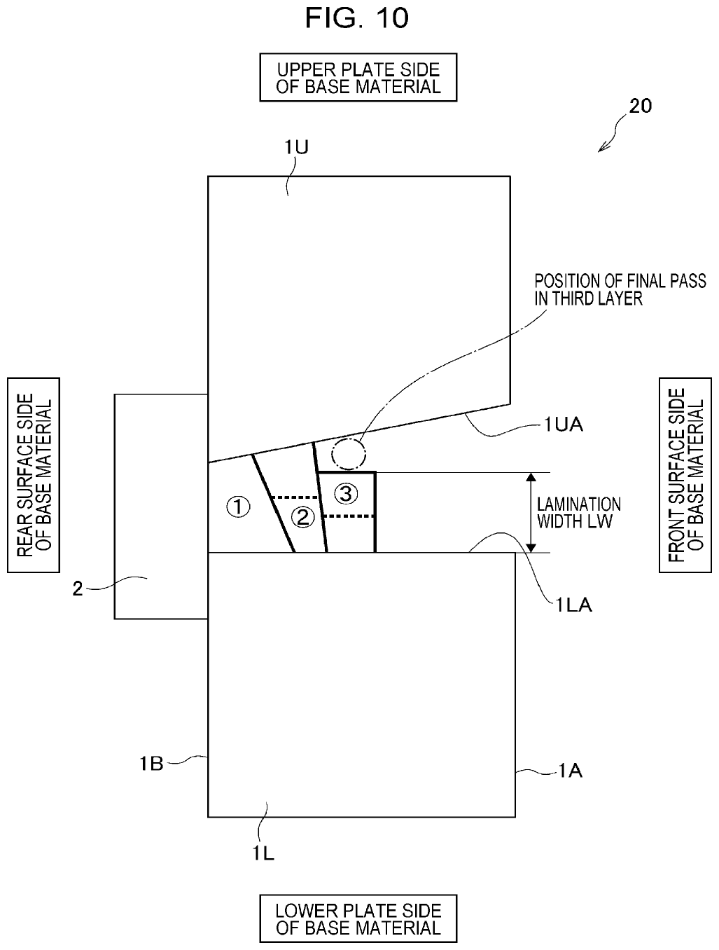

The target position for the wire tip in the final pass of each layer, that is, the weld pass in contact with the groove surface of the upper plate, is desirably located away from the groove surface of the upper plate serving as the base material by about 2 mm to 5 mm. A detailed description will be provided here with reference to FIG. 10. FIG. 10 illustrates a state immediately prior to welding the final pass in the third layer, that is, the weld pass in contact with the groove surface of the upper plate. If the aforementioned target position for the wire tip is located closer than 2 mm, such as in a range of 0 mm to 1 mm, from a groove surface 1UA of the upper plate 1U and is thus too close to the groove surface 1UA, an arc tends to form toward the groove surface 1UA, possibly causing a phenomenon where the arc length is not stable. An arc length variation may cause a large amount of spatter and an impaired external appearance of the joint. On the other hand, if the aforementioned target position for the wire tip is located farther than 5 mm, such as in a range greater than or equal to 6 mm, from the groove surface 1UA and is thus too far from the groove surface 1UA, an arc does not come into contact with the upper plate 1U serving as the base material and may cause a welding defect, such as incomplete fusion.

A lamination width LW immediately prior to welding the final pass has an effect on how the space for the final pass is ensured. For example, when the lamination width LW is too large, the space for welding the final pass decreases. On the other hand, when the lamination width LW is too small, the amount of weld in the final pass needs to be increased. Therefore, since the dimension of the lamination width LW immediately prior to welding the final pass acts as a factor that causes, for example, overlapping and bead sagging, an appropriate height needs to be set. The aforementioned lamination width LW refers to a width from a groove surface 1LA of the lower plate 1L to a position located the farthest from the groove surface 1LA in the weld pass welded immediately prior to welding the final pass.

The target position for the wire tip in the initial pass of each layer, that is, the weld pass in contact with the groove surface of the lower plate, is desirably located away from the groove surface 1LA of the lower plate 1L serving as the base material by about 1 mm to 3 mm. Because it is difficult to change the torch angle α in the portable welding robot 100, bead sagging tends to occur in horizontal-orientation welding. Therefore, with the target position for the wire tip being located away from the groove surface 1LA by about 1 mm to 3 mm, overlapping can be suppressed. Overlapping refers to an area with poor conformability between a bead toe and the base material and is defined as “an area where the weld metal WL does not fuse with the base material at the toe and overlaps therewith” in JIS Z 3001-4. In order to achieve favorable conformability, an improvement can be expected by optimizing the welding speed or by weaving.

### (C) Number of Lamination Layers and Number of Passes

The number of lamination layers and the number of passes are the most significant factors for adjusting the welding space, in addition to designing optimal shapes for the ground layer GL and the finishing layer FL described above.

Although an embodiment of the multi-pass welding method according to the present invention has been described in detail above based on the drawings, the present invention is not limited to the above embodiment and permits alterations and modifications, where appropriate.

For example, although the multi-pass welding method according to the present invention is suitably used in the welding system 50 equipped with the portable welding robot 100 according to this embodiment, the present invention is not limited to this and is also applicable to a welding system equipped with a six-axis welding robot.

Accordingly, the following items are disclosed in this description.

(1) A multi-pass welding method comprising forming weld metal by multi-pass welding in a horizontal orientation so as to join a pair of pieces of a base material constituted of an upper plate and a lower plate disposed to form a groove,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein the boundary layer is formed such that a position P_{UB} of an upper-plate-side weld at the boundary layer is closer to the front surface of the base material than a position P_{LB} of a lower-plate-side weld at the boundary layer.

According to this configuration, bead sagging can be minimized and a welded joint having a favorable weld metal surface can be formed even during multi-pass welding in a horizontal orientation.

(2) The multi-pass welding method according to (1), further comprising:
a step for setting at least two pieces of positional information among positional information about the position P_{UB}, positional information about the position P_{LB}, and relative positional information between the position P_{UB} and the position P_{LB} based on work information,
wherein the work information at least includes information about a groove shape, a groove angle, and a thickness of the base material.

According to this configuration, the boundary layer can be designed based on predetermined work information.

(3) The multi-pass welding method according to (1) or (2), wherein
a database in which work information and at least two pieces of positional information are associated with each other is provided, the work information at least including information about a groove shape, a groove angle, and a thickness of the base material, the at least two pieces of positional information being at least two pieces of positional information among positional information about the position P_{UB}, positional information about the position P_{LB}, and relative positional information between the position P_{UB} and the position P_{LB}, and
the multi-pass welding method further comprises a step for setting a lamination pattern based on the database, the lamination pattern including a number of lamination layers and a position of the boundary layer.

According to this configuration, the lamination pattern including the number of lamination layers and the position of the boundary layer can be set automatically based on the database in which the work information and the predetermined positional information are associated with each other.

(4) The multi-pass welding method according to any one of (1) to (3), wherein
the boundary layer is formed such that a distance D_{UB} from the front surface of the base material to the position P_{UB} ranges between 2 mm and 12 mm, and a distance D_{LB} from the front surface of the base material to the position P_{LB} ranges between 4 mm and 16 mm, and
a difference between the distance D_{UB} and the distance D_{LB} is between 1 mm and 10 mm inclusive.

According to this configuration, by forming the finishing layer at the front-surface side of the boundary layer, a joint with a favorable external appearance can be obtained with a small number of finishing layers.

(5) The multi-pass welding method according to any one of (1) to (4), wherein
in a case where a position of the upper-plate-side weld at an n-th layer is defined as P_{U(n)} and a position of the lower-plate-side weld at the n-th layer is defined as P_{L(n)},
the ground layer is formed such that a difference (D_{L(n)}−D_{U(n)} between a distance D_{L(n)} from the front surface of the base material to the position P_{L(n)} and a distance D_{U(n)} from the front surface of the base material to the position PU(m) increases sequentially until the boundary layer is reached.

According to this configuration, the boundary layer having a desired shape can be readily formed when a welded joint having a favorable weld metal surface is to be formed. Furthermore, the arithmetic expressions for determining the number of lamination layers and the number of passes are simplified, so that the lamination conditions can be readily calculated.

(6) The multi-pass welding method according to any one of (1) to (4), wherein
in a case where a position of the upper-plate-side weld at an n-th layer is defined as P_{U(n)} and a position of the lower-plate-side weld at the n-th layer is defined as P_{L(n)},
a plurality of layers with a positive difference (D_{L(n)}−D_{U(n)}) between a distance D_{L(n)} from the front surface of the base material to the position P_{L(n)} and a distance D_{U(n)} from the front surface of the base material to the position PU(m) are formed continuously from a predetermined layer of the ground layer until the boundary layer is reached.

According to this configuration, the boundary layer having a desired shape can be readily formed when a welded joint having a favorable weld metal surface is to be formed. Furthermore, a large amount of weld metal can be provided from the first layer toward the upper plate.

(7) The multi-pass welding method according to any one of (1) to (4), wherein
in a case where a position of the upper-plate-side weld at an n-th layer is defined as P_{U(n)} and a position of the lower-plate-side weld at the n-th layer is defined as P_{L(n)},
the ground layer is formed such that a difference (D_{L(n)}−D_{U(n)}) between a distance D_{L(n)} from the front surface of the base material to the position P_{L(n)} and a distance D_{U(n)} from the front surface of the base material to the position PU(m) alternates between positive and negative until the boundary layer is reached.

According to this configuration, the boundary layer having a desired shape can be readily formed when a welded joint having a favorable weld metal surface is to be formed. Furthermore, the space in the groove can be readily ensured, and the external appearance and the weld quality can both be readily achieved.

(8) A multi-pass butt welded joint in which a pair of pieces of a base material constituted of an upper plate and a lower plate disposed to form a groove are joined via weld metal formed by multi-pass welding,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein a position P_{UB} of an upper-plate-side weld at the boundary layer is closer to the front surface of the base material than a position P_{LB} of a lower-plate-side weld at the boundary layer.

According to this configuration, bead sagging can be minimized and a welded joint having a favorable weld metal surface can be obtained even during multi-pass welding in a horizontal orientation.

(9) The multi-pass butt welded joint according to (8), wherein
a distance D_{UB} from the front surface of the base material to the position P_{UB} ranges between 2 mm and 12 mm, and a distance D_{LB} from the front surface of the base material to the position P_{LB} ranges between 4 mm and 16 mm, and
a difference between the distance D_{UB} and the distance D_{LB} is between 1 mm and 10 mm inclusive.

According to this configuration, a welded joint with a favorable external appearance can be obtained with a small number of finishing layers.

(10) A lamination pattern calculation method for a multi-pass weld, the lamination pattern calculation method being for performing the multi-pass welding method according to (3), wherein
a database in which work information and at least two pieces of positional information are associated with each other is provided, the work information at least including information about a groove shape, a groove angle, and a thickness of the base material, the at least two pieces of positional information being at least two pieces of positional information among positional information about the position P_{UB}, positional information about the position P_{LB}, and relative positional information between the position P_{UB} and the position P_{LB}, and
the lamination pattern calculation method comprises a step for setting a lamination pattern based on the database, the lamination pattern including a number of lamination layers and a position of the boundary layer.

According to this configuration, the lamination pattern including the number of lamination layers and the position of the boundary layer can be set automatically based on the database in which the work information and the predetermined positional information are associated with each other.

Although various embodiments have been described above with reference to the drawings, the present invention is not limited to these examples. It is apparent that a skilled person may conceive of various modifications and corrections within the scope defined in the claims, and it is to be understood that such modifications and corrections belong to the technical scope of the present invention. The components in the above embodiments may be freely combined so long as they do not deviate from the scope of the invention.

The present application is based on Japanese Patent Application (2021-124523) filed on Jul. 29, 2021, the contents of which are hereby incorporated by reference.

### REFERENCE SIGNS LIST

1A front surface of base material
1B rear surface of base material
1L lower plate as base material
1U upper plate as base material
multi-pass butt welded joint
BL boundary layer

1. A multi-pass welding method comprising forming weld metal by multi-pass welding in a horizontal orientation so as to join a pair of pieces of a base material constituted of an upper plate and a lower plate disposed to form a groove,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein the boundary layer is formed such that a position P_{UB} of an upper-plate-side weld at the boundary layer is closer to the front surface of the base material than a position P_{LB} of a lower-plate-side weld at the boundary layer.

2. The multi-pass welding method according to claim 1, further comprising:
a step for setting at least two pieces of positional information among positional information about the position P_{UB}, positional information about the position P_{LB}, and relative positional information between the position P_{UB} and the position P_{LB} based on work information,
wherein the work information at least includes information about a groove shape, a groove angle, and a thickness of the base material.

3. The multi-pass welding method according to claim 1, wherein
a database in which work information and at least two pieces of positional information are associated with each other is provided, the work information at least including information about a groove shape, a groove angle, and a thickness of the base material, the at least two pieces of positional information being at least two pieces of positional information among positional information about the position PUB, positional information about the position PLB, and relative positional information between the position PUB and the position PLB, and
the multi-pass welding method further comprises a step for setting a lamination pattern based on the database, the lamination pattern including a number of lamination layers and a position of the boundary layer.

4. The multi-pass welding method according to claim 1, wherein
the boundary layer is formed such that a distance DUB from the front surface of the base material to the position PUB ranges between 2 mm and 12 mm, and a distance DLB from the front surface of the base material to the position PLB ranges between 4 mm and 16 mm, and
a difference between the distance DUB and the distance DLB is between 1 mm and 10 mm inclusive.

5. The multi-pass welding method according to claim 3, wherein
the boundary layer is formed such that a distance DUB from the front surface of the base material to the position PUB ranges between 2 mm and 12 mm, and a distance DLB from the front surface of the base material to the position PLB ranges between 4 mm and 16 mm, and
a difference between the distance DUB and the distance DLB is between 1 mm and 10 mm inclusive.

6. The multi-pass welding method according to claim 1, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) increases sequentially until the boundary layer is reached.

7. The multi-pass welding method according to claim 3, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) increases sequentially until the boundary layer is reached.

8. The multi-pass welding method according to claim 4, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) increases sequentially until the boundary layer is reached.

9. The multi-pass welding method according to claim 1, wherein
in a case where a position of the upper-plate-side weld at an n-th layer is defined as PU(n) and a position of the lower-plate-side weld at the n-th layer is defined as PL(n),
a plurality of layers with a positive difference (DL(n)−DU(n)) between a distance DL(n) from the front surface of the base material to the position PL(n) and a distance DU(n) from the front surface of the base material to the position PU(n) are formed continuously from a predetermined layer of the ground layer until the boundary layer is reached.

10. The multi-pass welding method according to claim 3, wherein
in a case where a position of the upper-plate-side weld at an n-th layer is defined as PU(n) and a position of the lower-plate-side weld at the n-th layer is defined as PL(n),
a plurality of layers with a positive difference (DL(n)−DU(n)) between a distance DL(n) from the front surface of the base material to the position PL(n) and a distance DU(n) from the front surface of the base material to the position PU(n) are formed continuously from a predetermined layer of the ground layer until the boundary layer is reached.

11. The multi-pass welding method according to claim 4, wherein
in a case where a position of the upper-plate-side weld at an n-th layer is defined as PU(n) and a position of the lower-plate-side weld at the n-th layer is defined as PL(n),
a plurality of layers with a positive difference (DL(n)−DU(n)) between a distance DL(n) from the front surface of the base material to the position PL(n) and a distance DU(n) from the front surface of the base material to the position PU(n) are formed continuously from a predetermined layer of the ground layer until the boundary layer is reached.

12. The multi-pass welding method according to claim 1, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) alternates between positive and negative until the boundary layer is reached.

13. The multi-pass welding method according to claim 3, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) alternates between positive and negative until the boundary layer is reached.

14. The multi-pass welding method according to claim 4, wherein
in a case where a position of the upper-plate-side weld at an n-th layer is defined as PU(n) and a position of the lower-plate-side weld at the n-th layer is defined as PL(n),
the ground layer is formed such that a difference (DL(n)−DU(n)) between a distance DL(n) from the front surface of the base material to the position PL(n) and a distance DU(n) from the front surface of the base material to the position PU(n) alternates between positive and negative until the boundary layer is reached.

15. A multi-pass butt welded joint in which a pair of pieces of a base material constituted of an upper plate and a lower plate disposed to form a groove are joined via weld metal formed by multi-pass welding,
wherein the weld metal has a plurality of layers from a rear surface to a front surface of the base material,
wherein the plurality of layers include
a finishing layer having at least two layers including an end layer, and
a ground layer located toward the rear surface of the base material relative to the finishing layer and including a boundary layer serving as a layer adjacent to the finishing layer, and
wherein a position PUB of an upper-plate-side weld at the boundary layer is closer to the front surface of the base material than a position PLB of a lower-plate-side weld at the boundary layer.

16. The multi-pass butt welded joint according to claim 15, wherein
a distance DUB from the front surface of the base material to the position PUB ranges between 2 mm and 12 mm, and a distance DLB from the front surface of the base material to the position PLB ranges between 4 mm and 16 mm, and
a difference between the distance DUB and the distance DLB is between 1 mm and 10 mm inclusive.

17. A lamination pattern calculation method for a multi-pass weld, the lamination pattern calculation method being for performing the multi-pass welding method according to claim 3, wherein
a database in which work information and at least two pieces of positional information are associated with each other is provided, the work information at least including information about a groove shape, a groove angle, and a thickness of the base material, the at least two pieces of positional information being at least two pieces of positional information among positional information about the position PUB, positional information about the position PLB, and relative positional information between the position PUB and the position PLB, and
the lamination pattern calculation method comprises a step for setting a lamination pattern based on the database, the lamination pattern including a number of lamination layers and a position of the boundary layer.
